(19) United States
(12) Patent Application Publication
(10) Pub. No.: US 2005/0036434 A1
(43) Pub. Date: Feb. 17, 2005

(54) Method for correcting the laser power by simulating recording process

(76) Inventor: Keng-Lon Lei, Hsin-Tien City (TW)

Correspondence Address: J C PATENTS, INC., 4 VENTURE, SUITE 250, IRVINE, CA, 92618, US

(21) Appl. No.: 10/714,337

(22) Filed: Nov. 13, 2003

(30) Foreign Application Priority Data
Aug. 15, 2003 (TW) 92122458

(51) Int. Cl. G11B 7/00

(52) U.S. Cl. 369/116; 369/59.11

(57) ABSTRACT

A method for correcting the laser power is provided. This method makes the optical pick-up head of the disk drive system operate in a low-power range and a tolerated high-power range, simulates the actual recording process to detect the laser power outside the upper-bound power, and obtain a better correcting curve, which could avoid affecting the quality of the disk recording.

### CROSS-REFERENCE TO RELATED APPLICATION

This application claims the priority benefit of Taiwan application serial no. 92122458, filed on Aug. 15, 2003 the full disclosure of which is incorporated herein by reference.

### BACKGROUND OF THE INVENTION

1. Field of the Invention

This invention generally relates to a method for correcting the laser power, and more particularly to a method for correcting the laser power by simulating recording process.

2. Description of the Related Art

In a CD/DVD drive system, in addition to a control circuit to access the data, an optical pick-up head takes charge of read/write operations. The disk has reflective material in its recording dye. During the data writing operation, the control circuit sets the laser power parameters of the optical pick-up head and controls an operation control signal. The optical pick-up head in response to the operation control signal intermittently emits the laser beams with a writing power to burn the reflective material. During the data reading operation, the optical pick-up head detects the reflective laser beams to obtain the data stored in the disk.

The laser power during the data writing operation is higher than that during the data reading operation. However, according to the specification of the optical pick-up head, the laser diode (LD), the device for emitting the laser beams, cannot continuously emit the laser beams with a writing power. Hence, while correcting the laser power parameter of the disk drive system, the LD emits the laser beams with a power lower than the writing power. In other words, the LD will emit the laser beams with a power below S, the upper bound below which the LD can continuously emit the laser beams according to the specification of the optical pick-up head. Then the curve fit and the extrapolation method will be used to estimate the relationship between the operational power parameter and the laser power outside the scope of the laser power S.

FIG. 1 shows a relationship between the power parameter and the laser power. The abscissa of FIG. 1 represents the operational power parameter of the disk drive system WDAC. The ordinate of FIG. 1 represents the detected laser power PW emitted from the LD. In FIG. 1, the conventional method for correcting the operational power parameter is to setup the operational power parameter WDAC and set the LD below the upper-bound power S to detect the real laser power PW emitted from the LD. Then the curve fit and the extrapolation method will be used to obtain the estimated correcting curve A for actual operations of the disk drive system.

Hence, the conventional method does not detect the laser power outside the scope of S. For example, assuming that the real correcting curve is curve B, the writing power is W, and the operational power parameter is D during the data writing operation. However, the LD during the data writing operation only emits the laser beams with a power W1 based on the real correcting curve B, which causes a writing power difference of W−W1. This power difference will seriously affect the quality of the disk recording.

### SUMMARY OF THE INVENTION

To overcome the drawback of the conventional method, the present invention provides a method for correcting the laser power by simulating the actual recording process to detect the laser power outside the upper-bound power and obtain the real correcting curve, which could avoid affecting the quality of the disk recording.

To achieve the above object, the present invention provides a method for correcting laser power by simulating a recording process, used for correcting a laser power of an optical disk drive system. The laser power is generated by an optical pick-up head of the optical disk drive system in response to an operational control signal and an operational power parameter. The method comprises: optionally defocusing the optical pick-up head; setting the operational control signal and the operational power parameter to make the optical pick-up head operate within the range that the optical pick-up head is not damaged (regardless of continuous operation or discrete operation); and measuring a sample holding value of the laser power generated by the optical pick-up head. The defocusing step is for preventing the tested disk from damage. If there is any way to prevent the tested disk from damage or to fix the tested disk, the defocusing step could be omitted.

Recording in a preferred embodiment of the present invention, the defocusing step could be performed by moving the optical pick-up head to a side of a focus, or by removing the optical pick-up head from a focus. Further, the defocusing step could be also performed by rotating the optical pick-up head such that the focus of the optical pick-up head is not located on the tested disk, or by changing the distance between the optical pick-up head and a tested disk such that the focus of the optical pick-up head is not located on the tested disk.

Further, in a preferred embodiment of the present invention, the method further comprises changing the operational power parameter and measuring another sample holding value of the laser power generated by the optical pick-up head. Then a curve fit method could be applied to obtain a curve representing a relationship between the operational power parameter and the laser power based on the measured sample holding values. The applied operational control signal has a duty cycle less than a duty cycle specified in a specification of the optical pick-up head (e.g., 50%) to prevent the optical pick-up head from damage due to the continuous operation outside the upper-bound power S. In addition, the sample holding value is obtained by measuring the laser power via an output of a sample holding circuit.

The present invention also provides a method for correcting laser power by simulating a recording process, used for an optical disk drive system. The optical disk drive system in response to an operational control signal and an operational power parameter controls an optical pick-up head to generate laser beams with a laser power. The method comprises: optionally defocusing the optical pick-up head; setting the operational power parameter; causing the operational control signal to be the same as an operational control signal for an actual disk recording process; transferring the laser beams to a signal, sampling and holding the signal to obtain a sample holding signal; obtaining the laser power based on the sample holding signal; and changing the operational power parameter and repeating the above steps to obtain another the laser power.

Because the present invention simulates a real recording process to correct the laser power. Hence, the present invention could measure the laser power outside the upper-bound power S to obtain a better correcting curve. Therefore, the present invention could avoid affecting the quality of the disk recording.

In a preferred embodiment of the present invention, a curve fit method could be applied to obtain a curve representing a relationship between the operational power parameter and the laser power based on the operational power parameters and the laser powers.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 shows a relationship between the power parameter and the laser power.

FIG. 2 is a block diagram of the control circuit of a disk drive system in the control circuit in accordance with the first embodiment of the present invention.

FIG. 3 is a waveform-time diagram for signals in the control circuit in accordance with the first embodiment of the present invention.

FIG. 4 shows one comparison between the present invention and the conventional method.

FIG. 5 shows another comparison between the present invention and the conventional method.

### DESCRIPTION OF THE PREFERRED EMBODIMENTS

FIG. 2 is a block diagram of the control circuit of a disk drive system in the control circuit in accordance with the first embodiment of the present invention. Referring to FIG. 2, the control circuit 200 sets an operational power parameter WDAC to control the LD to emit the laser power PW. In other words, during the data reading/writing operations, the laser power PW is determined by setting the operational power parameter WDAC.

Referring to FIG. 2, the control circuit 200 comprises a digital/analog (D/A) converter 220, a comparator 230, an integrator 240, a sample holding circuit 250, an amplifier 260, an LD driver circuit 211, an LD 212 and a front photo diode (FPD) 213. The LD driver circuit 211, the LD 212, and the FPD 213 are within the optical pick-up head 210. The D/A converter 220, the comparator 230, the integrator 240, the sample holding circuit 250, and the amplifier 260 are within the disk control chip (not shown).

When the disk drive system reads from or writes to the disk, the system will set the operational power parameter WDAC based on the required laser power PW. The operational power parameter WDAC is converted to an analog value S1 through the D/A converter 220 and is inputted into the comparator 230. Another input of the comparator 230 receives the detected value S2 of the laser power PW emitted from the LD 212 from of the feedback loop consisting of the FPD 213, the sample holding circuit 250, and the amplifier 260. The difference between S1 and S2 is E. The integrator 240 integrates the difference between S1 and S2 to output an integrated value SI. SI is inputted into the LD driver circuit 211 to drive the LD 212 emitting the laser beams. When the detected value S2 converted from the feedback loop the laser power of the laser beams emitted from the LD 212 is equal to the analog value S1, the output E of the amplifier 230 is zero. The integrator 240 thus can output a stable integrated value SI. Therefore, the control circuit 200 can control the laser power precisely corresponding to the operational power parameter WDAC.

The feedback loop uses the FPD 213 to detect the laser power PW emitted from the LD 212. The FPD 213 then outputs a signal FPDO. The laser power PW is proportional to the difference between the reference voltage Vref and FPDO. For example, PW/(Vref−FPDO)=20 mw/500 mv. Hence, when the laser power PW is higher, the voltage level of FPDO is lower. Further, when the disk drive system reads from or writes to the disk, the system will use the control signal OUTEN to turn on/off the LD 212 through the LD driver circuit 211 in order to perform read/write operations. The sample holding circuit 250 uses the sample control signal FPDSH corresponding to the control signal OUTEN to obtain the sample holding value of the FPDO signal, Vsh. The sample holding value Vsh is amplified by the amplifier 260 to become the detected value S2. To maintain the corresponding relationship between the detected value S2 and the analog value S1, the amplifier 260 could be a negative-gain amplifier.

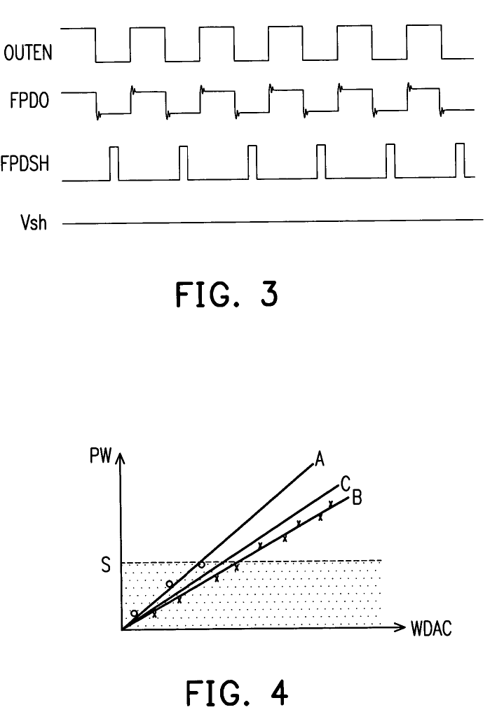

FIG. 3 is a waveform-time diagram for signals in the control circuit in accordance with the first embodiment of the present invention. Referring to FIGS. 2 and 3, the method for correcting the laser power of the present invention does not limit the operational laser power PW to the upper-bound power specified in the specification of the optical pick-up head 210. Hence before using this method to correct the laser power, if the operational laser power PW is within the high-power range, to prevent the tested disk from damage, a defocusing step could be performed to defocus the optical pick-up head 210. The defocusing step could be performed by moving the optical pick-up head 210 to a side of a focus, or by removing the optical pick-up head 210 from a focus. Further, the defocusing step could be also performed by rotating the optical pick-up head such that the focus of the optical pick-up head is not located on the tested disk, or by changing the distance between the optical pick-up head and a tested disk such that the focus of the optical pick-up head is not located on the tested disk. If there is any way to prevent the tested disk from damage or to fix the tested disk, the defocusing step could be omitted.

After the optional defocusing step is performed, the operational control signal OUTEN and the operational power parameter WDAC can be set to make the optical pick-up head 210 operate within a range free of damage. That is, when the laser power PW corresponding to the set operational power parameter WDAC, the duty cycle of the operational control signal OUTEN has to be lower than the duty cycle the optical pick-up head 210 can tolerate; e.g., less than 50% as shown in FIG. 3.

Then the sample holding value Vsh is measured by using the FPD 213 to detect the laser power PW from the LD 212 and obtain the FPDO signal, and by using the sample holding circuit 250 to sample and hold the FPDO signal based on the sample control signal FPDSH. One skilled in the art also can measure the amplifier output value S2 to obtain the laser power PW.

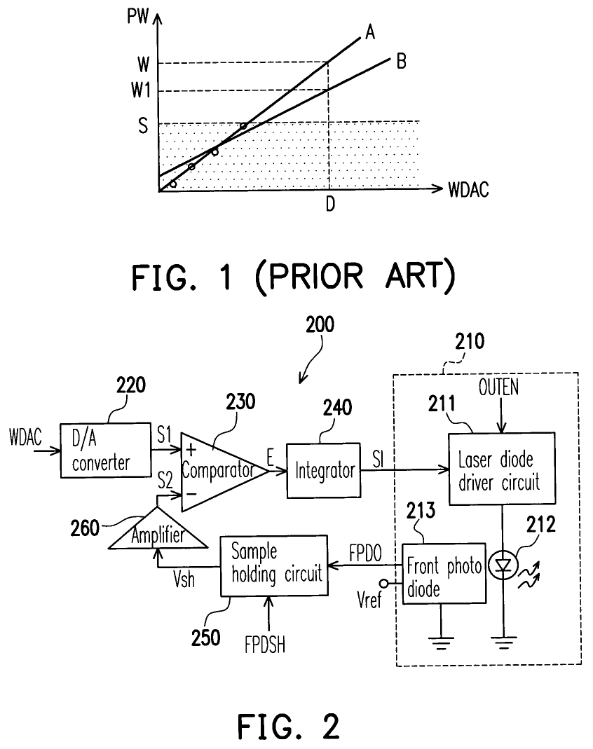

Therefore, by changing the operational power parameter WDAC and measuring another sample holding value Vsh of the laser power PW generated by the optical pick-up head 210, a curve fit method can be applied to obtain a real correcting curve B representing a relationship between the operational power parameter WDAC and the laser power PW based on the measured sample holding values. By applying the real correcting curve B in the disk drive system, the writing power difference of W−W1 as shown in FIG. 1 can be eliminated.

FIG. 4 shows the comparison between the present invention and the conventional method. Curve C is the real curve (linear curve) showing the relationship between the operational power parameter WDAC and the laser power PW. Curve A is the curve obtained based on the conventional method. Curve B is the curve obtained based on the preferred embodiment of the present invention. As shown in FIG. 4, the present invention can correct the laser power outside the upper-bound power S. Hence, Curve B is much close to Curve C.

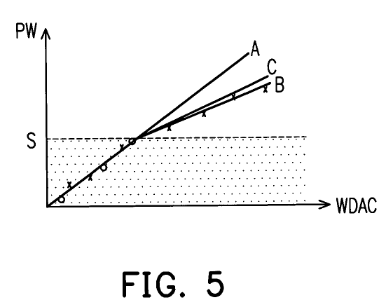

FIG. 5 shows another comparison between the present invention and the conventional method. Curve C is the real curve (nonlinear curve) showing the relationship between the operational power parameter WDAC and the laser power PW. Curve A is the curve obtained based on the conventional method. Curve B is the curve obtained based on the preferred embodiment of the present invention. As shown in FIG. 4, because the conventional method only can correct the laser power below the upper-bound power S, Curve A seriously deviates from Curve C outside the upper-bound power S. Unlike the conventional method, the present invention can correct the laser power outside the upper-bound power S. Hence, Curve B is much close to Curve C.

In brief, the method for correcting the laser power of the present invention has the following advantages:

1. Because the present invention simulates a real recording process to correct the laser power. Hence, the present invention can measure the laser power outside the upper-bound power S to obtain a better correcting curve. Therefore, the present invention could avoid affecting the quality of the disk recording, especially avoiding the effect induced by non-enough sample range or the non-liner character of the relationship between the operational power parameter WDAC and the laser power PW.

2. Before correcting the laser power, the defocusing step or other equivalent step(s) has been performed. Hence, it can prevent the tested disk from damage.

3. The applied operational control signal OUTEN has a duty cycle less than a duty cycle specified in a specification of the optical pick-up head to prevent the optical pick-up head from damage due to the continuous operation outside the upper-bound power S.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method for correcting laser power by simulating a recording process, used for correcting a laser power of a optical disk drive system, said laser power being generated by an optical pick-up head of said optical disk drive system in response to an operational control signal and an operational power parameter, said method comprising:
setting said operational control signal and said operational power parameter such that said optical pick-up head is not damaged by the operation range of said optical pick-up head; and
measuring a sample holding value of said laser power generated by said optical pick-up head.

2. The method of claim 1, further comprising:
defocusing said optical pick-up head before measuring said sample holding value.

3. The method of claim 2, wherein said defocusing step is performed by rotating said optical pick-up head such that the focus of said optical pick-up head is not located on the tested disk.

4. The method of claim 2, wherein said defocusing step is performed by changing the distance between said optical pick-up head and a tested disk such that the focus of said optical pick-up head is not located on the tested disk.

5. The method of claim 2, wherein said defocusing step is performed by moving said optical pick-up head to a side of a focus.

6. The method of claim 2, wherein said defocusing step is performed by removing said optical pick-up head from a focus.

7. The method of claim 1, further comprising:
changing said operational power parameter; and
measuring a plurality of sample holding values of said laser power generated by said optical pick-up head in accordance with different said optional power parameters.

8. The method of claim 7, further comprising:
applying a curve fit method to obtain a curve representing a relationship between said operational power parameter and said laser power based on said measured sample holding values.

9. The method of claim 1, wherein said operational control signal has a duty cycle less than a duty cycle specified in a specification of said optical pick-up head.

10. The method of claim 1, wherein said sample holding value is obtained by measuring said laser power via an output of a sample holding circuit.

11. A method for correcting laser power by simulating a recording process, used for a optical disk drive system, said optical disk drive system in response to an operational control signal and an operational power parameter controlling an optical pick-up head to generate laser beams with a laser power, said method comprising:
setting said operational power parameter;
causing said operational control signal to be the same as an operational control signal for an actual disk recording process;
transferring said laser beams to a signal, sampling and holding said signal to obtain a sample holding signal;
obtaining said laser power based on said sample holding signal; and
changing said operational power parameter and repeating the above steps to obtain another said laser power.

12. The method of claim 11, further comprising:
applying a curve fit method to obtain a curve representing a relationship between said operational power parameter and said laser power based on said operational power parameters and said laser powers.

13. The method of claim 11, further comprising:
defocusing said optical pick-up head before transferring said laser beams.

14. The method of claim 13, wherein said defocusing step is performed by rotating said optical pick-up head such that the focus of said optical pick-up head is not located on the tested disk.

15. The method of claim 13, wherein said defocusing step is performed by changing the distance between said optical pick-up head and a tested disk such that the focus of said optical pick-up head is not located on the tested disk.

16. The method of claim 13, wherein said defocusing step is performed by moving said optical pick-up head to a side of a focus.

17. The method of claim 13, wherein said defocusing step is performed by removing said optical pick-up head from a focus.
